(19) United States
(12) Patent Application Publication
(10) Pub. No.: US 2024/0091893 A1
(43) Pub. Date: Mar. 21, 2024

(54) MOUNTING FRAME FOR A SCREWING MACHINE

(71) Applicant: Jabil Inc., St. Petersburg, FL (US)

(72) Inventors: Harpuneet Singh, Dublin, CA (US); Lei Hu, Singapore (SG); Ying-Chieh Huang, Jingzhou City (CN); Wei-Hsiu Hsieh, Lugang Town (TW); Xiao-Ting Zheng, Shanwei City (CN); Chien-Cheng Chu, Taichung City (TW)

(73) Assignee: Jabil Inc., St. Petersburg, FL (US)

(21) Appl. No.: 18/450,687

(22) Filed: Aug. 16, 2023

(30) Foreign Application Priority Data
Sep. 15, 2022 (MY) UI 2022005055

(51) Int. Cl. B23P 19/06

(52) U.S. Cl. CPC B23P 19/069

(57) ABSTRACT

A mounting frame for being mounted with either one of first and second screwdrivers, includes a main frame, a mounting seat, and first and second mounting plates. The mounting seat has a plate attachment hole set. The first mounting plate has a first seat attachment hole set operable to be connected to the plate attachment hole set, and a first driver attachment hole set for the first screwdriver to be attached thereto. The second mounting plate has a second seat attachment hole set operable to be connected to the plate attachment hole set, and a second driver attachment hole set for the second screwdriver to be attached thereto.

### CROSS-REFERENCE TO RELATED APPLICATION

This application claims priority to Malaysia Utility Innovation Application No. UI 2022005055, filed on Sep. 15, 2022.

### FIELD

The disclosure relates to a mounting apparatus, and more particularly to a mounting frame for a screwing machine.

### BACKGROUND

A conventional screwing machine includes a base, and a mounting seat that is movably mounted to the base and that is mounted with a screwdriver for fastening a screw onto a workpiece. For fastening a specific type of screw, a specific screwdriver selected from several configurationally different screwdrivers is adopted. However, for mounting a different screwdriver to the base, a specific mounting seat with a configuration corresponding to the different screwdriver should be mounted to the base to replace the original mounting seat. In other words, when attaching different screwdrivers to the base in turn, a different mounting seat must be mounted to the base for each of the different screwdrivers, and replacement of the mounting seats is laborious and time-consuming.

### SUMMARY

Therefore, an object of the disclosure is to provide a mounting frame that can alleviate the drawback of the prior art.

According to an aspect of the disclosure, the mounting frame is adapted for a screwing machine and for being mounted with either one of configurationally different first and second screwdrivers, and includes a main frame, a mounting seat, a first mounting plate and a second mounting plate. The mounting seat is mounted to the main frame, and has a plate attachment hole set. The first mounting plate has a first seat attachment hole set that is operable to be separably connected to the plate attachment hole set of the mounting seat, and a first driver attachment hole set that is adapted for the first screwdriver to be attached thereto. The second mounting plate has a second seat attachment hole set that is operable to be separably connected to the plate attachment hole set of the mounting seat, and a second driver attachment hole set that is adapted for the second screwdriver to be attached thereto.

According to an aspect of the disclosure, the mounting frame is adapted for a screwing machine and for being mounted with either one of configurationally different first and second screwdrivers, and includes a main frame, a mounting seat, a first mounting plate and a second mounting plate. The mounting seat is mounted to the main frame. The first mounting plate is operable to be separably connected to the plate attachment hole set of the mounting seat, and has a first driver attachment hole set that is adapted for the first screwdriver to be attached thereto. The second mounting plate is operable to be separably connected to the plate attachment hole set of the mounting seat, and has a second driver attachment hole set that is adapted for the second screwdriver to be attached thereto. The first driver attachment hole set of the first mounting plate is different from the second driver attachment hole set of the second mounting plate, so that when the first screwdriver is attached to the mounting seat by the first mounting plate, a height position of a driver bit of the first screwdriver is the same as a height position of a driver bit of the second screwdriver when the second screwdriver is attached to the mounting seat by the second mounting plate.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly exploded perspective view illustrating an embodiment of the mounting frame according to the disclosure.

FIG. 2 is another partly exploded perspective view illustrating the embodiment.

FIG. 3 is a fragmentary, partly exploded perspective view illustrating the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

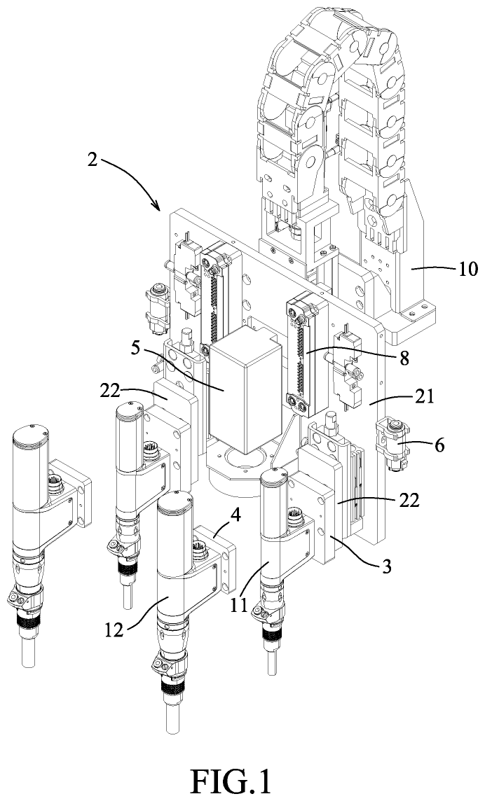

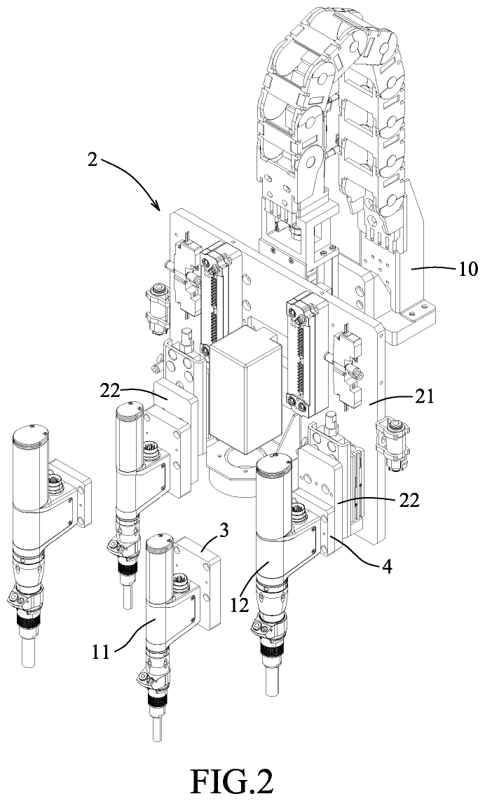

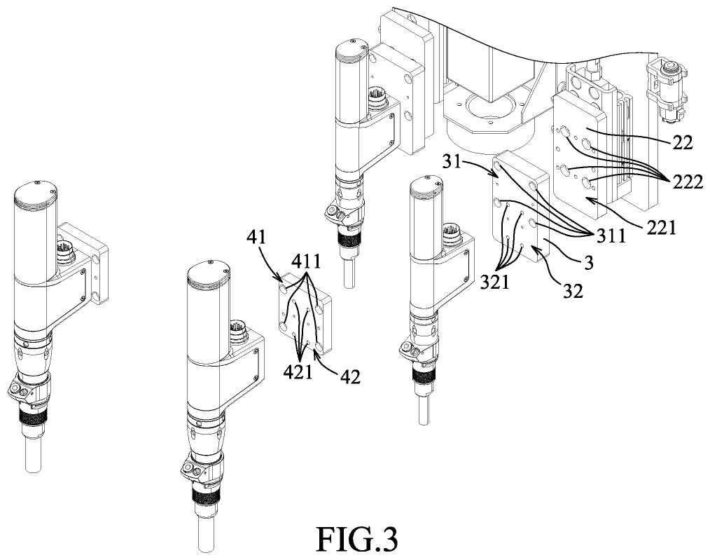

Referring to FIGS. 1 to 3, an embodiment of the mounting frame 2 according to the disclosure is for being mounted with either one of configurationally different first and second screwdrivers 11, 12, and includes a main frame 21, at least one mounting seat 22, at least one first mounting plate 3 for attaching the first screwdriver 11 to the mounting seat 22 (see FIG. 1), and at least one second mounting plate 4 for attaching the second screwdriver 12 to the mounting seat 22 (see FIG. 2).

The main frame 21 is movably mounted to a base 10 of a screwing machine.

The mounting seat 22 is mounted to the main frame 21, and has a plate attachment hole set 221. In one embodiment, the mounting seat 22 may be movably mounted to the main frame 21 for setting an initial position of a screwdriver mounted to the mounting seat 22.

The first mounting plate 3 has a first seat attachment hole set 31 that is operable to be separably connected to the plate attachment hole set 221 of the mounting seat 22, and a first driver attachment hole set 32 that is adapted for the first screwdriver 11 to be attached thereto for fastening a specific screw.

The second mounting plate 4 has a second seat attachment hole set 41 that is operable to be separably connected to the plate attachment hole set 221 of the mounting seat 22, and a second driver attachment hole set 42 that is adapted for the second screwdriver 12 to be attached thereto for fastening another specific screw.

Either one of the first and second mounting plates 3, 4 can be selected to be mounted to the mounting seat 22 for attaching a corresponding one of the first and second screwdrivers 11, 12 to the mounting seat 22. In one embodiment, the configuration of the first driver attachment hole set 32 is different from the configuration of the second driver attachment hole set 42.

In one embodiment, the plate attachment hole set 221 of the mounting seat 22 includes at least one plate attachment hole 222, and the first seat attachment hole set 31 of the first mounting plate 3 includes at least one first seat attachment hole 311 that is connected to the plate attachment hole 222 by a pin, a bolt, a screw or the like when the first mounting plate 3 is mounted to the mounting seat 22. Similarly, the second seat attachment hole set 41 of the second mounting plate 4 may include at least one second seat attachment hole 411 that is connected to the plate attachment hole 222 by a pin, a bolt, a screw or the like when the second mounting plate 4 is mounted to the mounting seat 22. In this embodiment, the plate attachment hole set 221 of the mounting seat 22 includes four plate attachment holes 222, the first seat attachment hole set 31 of the first mounting plate 3 includes four first seat attachment holes 311, and the second seat attachment hole set 41 of the second mounting plate 4 includes four second seat attachment holes 411.

In one embodiment, the first driver attachment hole set 32 of the first mounting plate 3 includes at least one first driver attachment hole 321, and the first screwdriver 11 is attached to the first driver attachment hole 321 by a pin, a bolt, a screw or the like. Similarly, the second driver attachment hole set 42 of the second mounting plate 4 may include at least one first driver attachment hole 421, and the second screwdriver 12 is attached to the second driver attachment hole 421 by a pin, a bolt, a screw or the like. In this embodiment, the first driver attachment hole set 32 of the first mounting plate 3 includes four first driver attachment holes 321, and the second driver attachment hole set 42 of the second mounting plate 4 includes four first driver attachment holes 421.

In one embodiment, relative positions of the first seat attachment hole set 31 and the first driver attachment hole set 32 of the first mounting plate 3 are different from relative positions of the second seat attachment hole set 41 and the second driver attachment hole set 42 of the second mounting plate 4. By such, the relative difference in length between the first and second screwdrivers 11, 12 may be accounted for, and when the first screwdriver 11 is attached to the mounting seat 22 by the first mounting plate 3, the height position of a driver bit of the first screwdriver 11 may be the same as the height position of a driver bit of the second screwdriver 12 when the second screwdriver 12 is attached to the mounting seat 22 by the second mounting plate 4.

In one embodiment, the mounting frame 2 further includes additional mounting plate(s) (not shown) for attaching different screwdriver(s) to the mounting seat 22.

In one embodiment, the mounting frame 2 may includes a plurality of mounting seats 22 that are mounted to the main frame 21. The number of each of the first and second mounting plates 3, 4 corresponds to the number of the mounting seats 22.

In summary, by virtue of the first and second mounting plates 3, 4, either one of the first and second screwdrivers 11, 12 can be easily attached to the mounting seat 22 without substituting the mounting seat 22 with a replacement one. The replacement operation of the first and second screwdrivers 11, 12 according to the disclosure is therefore labor-saving and time-saving.

In one embodiment, the mounting frame 2 may be provided with an image capture module 5 for capturing images of the driver bit of the screwdriver, the screw held by the driver bit and a workpiece onto which the screw may be fastened. In one embodiment, the image capture module 5 may be an assembly of a liquid tunable lens and a charge coupled device (CCD).

In one embodiment, the mounting frame 2 may be provided with a vacuum generator 6 that is connected to the screwdriver mounted to the mounting seat 22 (by conduits) for drawing and picking screws. In one embodiment, the mounting frame 2 may be further provided with a filter (not shown) that is disposed between the vacuum generator 6 and the screwdriver mounted to the mounting seat 22 for preventing debris generated in the fastening operation of the screws from entering the vacuum generator

In one embodiment, the mounting frame 2 may be provided with an action recording module 8 for recording the action of the main frame 21, the mounting seat 22 and the screwdrivers.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A mounting frame adapted for a screwing machine and for being mounted with either one of configurationally different first and second screwdrivers, comprising:
a main frame;
a mounting seat mounted to the main frame, and having a plate attachment hole set;
a first mounting plate having a first seat attachment hole set that is operable to be separably connected to the plate attachment hole set of the mounting seat, and a first driver attachment hole set that is adapted for the first screwdriver to be attached thereto; and
a second mounting plate having a second seat attachment hole set that is operable to be separably connected to the plate attachment hole set of the mounting seat, and a second driver attachment hole set that is adapted for the second screwdriver to be attached thereto.

2. The mounting frame as claimed in claim 1, wherein relative positions of the first seat attachment hole set and the first driver attachment hole set of the first mounting plate are different from relative positions of the second seat attachment hole set and the second driver attachment hole set of the second mounting plate.

3. The mounting frame as claimed in claim 1, wherein the plate attachment hole set of the mounting seat includes at least one plate attachment hole.

4. The mounting frame as claimed in claim 1, wherein the first seat attachment hole set of the first mounting plate includes at least one first seat attachment hole, and the first driver attachment hole set of the first mounting plate includes at least one first driver attachment hole.

5. The mounting frame as claimed in claim 1, wherein the second seat attachment hole set of the second mounting plate includes at least one second seat attachment hole, and the second driver attachment hole set of the second mounting plate includes at least one first driver attachment hole.

6. The mounting frame as claimed in claim 1, further comprising an image capture module for capturing images.

7. The mounting frame as claimed in claim 1, further comprising a vacuum generator that is adapted to be connected to one of the first and second screwdrivers mounted to the mounting seat.

8. The mounting frame as claimed in claim 7, further comprising a filter that is disposed between the vacuum generator and the one of the first and second screwdrivers mounted to the mounting seat.

9. A mounting frame adapted for a screwing machine and for being mounted with either one of configurationally different first and second screwdrivers, comprising:
a main frame;
a mounting seat mounted to the main frame;
a first mounting plate operable to be separably connected to the mounting seat, and having a first driver attachment hole set that is adapted for the first screwdriver to be attached thereto; and
a second mounting plate operable to be separably connected to the mounting seat, and having a second driver attachment hole set that is adapted for the second screwdriver to be attached thereto;
wherein the first driver attachment hole set of the first mounting plate is different from the second driver attachment hole set of the second mounting plate, so that when the first screwdriver is attached to the mounting seat by the first mounting plate, a height position of a driver bit of the first screwdriver is the same as a height position of a driver bit of the second screwdriver when the second screwdriver is attached to the mounting seat by the second mounting plate.

10. The mounting frame as claimed in claim 9, wherein the mounting seat has a plate attachment hole set, the first mounting plate having a first seat attachment hole set that is operable to be separably connected to the plate attachment hole set of the mounting seat, the second mounting plate having a second seat attachment hole set that is operable to be separably connected to the plate attachment hole set of the mounting seat, relative positions of the first seat attachment hole set and the first driver attachment hole set of the first mounting plate being different from relative positions of the second seat attachment hole set and the second driver attachment hole set of the second mounting plate.

11. The mounting frame as claimed in claim 10, wherein the plate attachment hole set of the mounting seat includes at least one plate attachment hole.

12. The mounting frame as claimed in claim 10, wherein the first seat attachment hole set of the first mounting plate includes at least one first seat attachment hole, and the first driver attachment hole set of the first mounting plate includes at least one first driver attachment hole.

13. The mounting frame as claimed in claim 10, wherein the second seat attachment hole set of the second mounting plate includes at least one second seat attachment hole, and the second driver attachment hole set of the second mounting plate includes at least one first driver attachment hole.

14. The mounting frame as claimed in claim 9, further comprising an image capture module for capturing images.

15. The mounting frame as claimed in claim 9, further comprising a vacuum generator that is adapted to be connected to one of the first and second screwdrivers mounted to the mounting seat.

16. The mounting frame as claimed in claim 15, further comprising a filter that is disposed between the vacuum generator and the one of the first and second screwdrivers mounted to the mounting seat.
